(19) United States
(12) Patent Application Publication
(10) Pub. No.: US 2021/0346827 A1
(43) Pub. Date: Nov. 11, 2021

(54) ACTIVE AIR FILTER FOR TREATMENT OF BACTERIA AND VIRUSES

(71) Applicant: LIGC Application Ltd, Zichron Yaakov (IL)

(72) Inventors: Ishay OSTFELD, Ramat Gan (IL); Kobi BEN-SHABAT, Caesarea (IL)

(21) Appl. No.: 17/330,215

(22) Filed: May 25, 2021

Related U.S. Application Data
(63) Continuation-in-part of application No. 17/190,239, filed on Mar. 2, 2021.
(60) Provisional application No. 62/983,912, filed on Mar. 2, 2020.

(51) Int. Cl. B01D 39/16; B01D 39/20

(52) U.S. Cl. CPC B01D 39/1623; B01D 39/1692; B01D 39/2065; B01D 2239/0442; B01D 2239/0241; B01D 2239/0478; B01D 2257/91

(57) ABSTRACT

An active air filter device for disrupting or destroying bacteria and/or viruses, the filter including at least one layer of porous conductive material, and energy source creating current and/or voltage and/or electric field and/or magnetic field, propagated throughout the conductive material.

The present application is a continuation-in-part of application Ser. No. 17/190,239, the entire disclosure of which is incorporated by reference herein.

### FIELD OF THE INVENTION

The present invention relates to the field of bacteria, viruses and particles filtration. More specifically, the present invention relates to an active air filter for destroying bacteria and/or viruses and toxins.

### BACKGROUND OF THE INVENTION

Current filter solutions, such as the common face masks have proven inadequate, as they do not filter very small microorganisms and other particles, they do not destroy the mnicroorganisms and their toxins, and are active for only short period of time.

Moreover, current filter may become a bed for growing, microorganisms.

Therefore, there is a need for a new approach, providing an active, adaptive solution.

Removal of airborne pathogens such as bacteria, viruses, fungi, and spores can lead to an improvement of public health and especially in places such as hospitals where immune compromised individuals can be easily infected. Removal of these infectious particles from contaminated air can be achieved with air filters, which usually trap the particles based on size. For example, state-of-the-art high-efficiency particulate air (HEPA) filters can remove >99% of airborne particles, however, these filters are costly and accumulation and proliferation of microbes in the filter are associated problems. In heating, ventilation, and air-conditioning (HVAC) systems, deposited microbes can form biofilms especially if moisture is present or humidity is high, and the installed filter efficiency gradually decreases. Thus, the combination of filtration technology with strategies that increase the toxicity to bacteria or inactivate viral particles might lead to more efficient and effective air purification devices.

Strategies to inactivate pathogens using air filters include coatings, for example quaternary ammonium functionalized polyurethane coatings have been applied to HEPA filters for bactericidal activity and coated tannic acid coated HEPA filters could trap influenza viral particles. However, in general, filter coatings can lose effectiveness as a buildup of microorganisms or dust can prevent contact between the antimicrobial agent coated on the surface of the filter and the microorganisms. Nonetheless, many filter coatings have been reported such as copper and silver, known for their excellent antimicrobial properties against a variety of different micro-organisms, and can be effective for short term use. Other strategies to enhance the biological activity of filters use external stimuli or a combination of technologies such as UV with filtration. For example, photo-catalytic metal organic framework based filters could inactivate Escherichia coli under solar irradiation as well as remove small particles. However, challenges to commercialize such a filter might include material costs and that sunlight exposure in current HVAC systems is not practical. However, filters with electrically conductive surfaces might lead to surface biological activity under electric potential or electrical current, and functional, cost effective self-sterilizable filters have been shown. (Stanford M. G.; Li, J. T.; Chen, Y.; McHugh E. A.; Liopo, A.; Xiao, H.; Tour, J. M.: Self-sterilizing laser-induced graphene bacterial air filter. ACS nano 2019, 13, 11912-11920.)

### SUMMARY OF THE INVENTION

The present invention provides an active air filter device for disrupting or destroying bacteria and/or viruses, said filter comprised of:
at least one layer of porous conductive material;
energy source creating current and/or voltage and/or electric field and/or magnetic field, propagated throughout the said conductive material.

The present invention provides an active air filter device for disrupting or destroying bacteria and/or viruses their toxins and other particles.

The filter may be made of at least one layer of a porous conductive material, for instance, carbon-based porous material such as LIG (Laser induced Graphene).

In accordance with some embodiments of the present invention, the filter device may comprise an energy source which creates current, or voltage or electromagnetic fields, or magnetic field that propagates through the porous conductive material. The energy source may be an internal part of the device or external part such as a battery, an electrical socket or a compute device that is electrically connected to the filter device.

The present invention disclose an active air filter device for disrupting or destroying bacteria and/or viruses, said filter comprised of:
at least one layer of porous conductive material;
energy source creating current, propagated throughout the said conductive material.

In accordance with some embodiments of the present invention the porous conductive material is carbon-based porous material.

In accordance with some embodiments of the present invention the porous conductive material has current density at the range of 6 mA cm⁻² to 20 mA cm².

In accordance with some embodiments of the present invention the porous conductive material is LIG (Laser-induced graphene) using fabricated LIG on non-woven polyimide fabric, wherein the created current emits low heat.

In accordance with some embodiments of the present invention the porous conductive material comprise at least one of polyimide based non-woven substrate (P84), a PTFE coated P84 non woven substrate (C-P84) and an aromatic polyamide (Aramid) non-woven substrate (AN).

In accordance with some embodiments of the present invention the Laser-induced graphene LIG is fabricated using a CO₂ laser at ambient atmosphere where in the laser power and the scanning speed are varied.

In accordance with some embodiments of the present invention the porous conductive material is made of one sided layer.

In accordance with some embodiments of the present invention the porous conductive material is made of at least two sides layers.

In accordance with some embodiments of the present invention the porous conductive carbon-based material is integrated with other active or passive layers of other materials including at least one of: polyesterfibre (non-wetting), standard air filter, Chemical/Chemically as impregnated material by Antibiotics, Alcohol, Chlorhexidine, Iodine, or Metal-based material or Materials Impregnated with metal, cooper and/or silver, and/or lead.

In accordance with some embodiments of the present invention the energy source is controlled automatically by a control module, which is implemented as a management application on an associated computer device.

In accordance with some embodiments of the present invention the current emerging from the energy source may be either a direct current or an alternating current, continuously, or intermittently at a given time and/or its form may be electric pulses of various shapes.

In accordance with some embodiments of the present invention the current is pulsed in predefined cycles or according to predefined rules, wherein the predefined rules are based on the condition of the filter by sensing the cleanliness of the filter is or if bacteria or virus where detected on the filter.

In accordance with some embodiments of the present invention the filter materials comprise chemicals materials including antibiotics or alcohol.

In accordance with some embodiments of the present invention wherein material is pre-set to provide the static electricity.

In accordance with some embodiments of the present invention the static electricity emerges by the user, by subbing the outside surface of the filter or by inner layers designed to be movably interconnected.

In accordance with some embodiments of the present invention the active filter device can be used for a room air filtering independent device or as part of an air-condition system, in buildings or vehicles.

In accordance with some embodiments of the present invention comprise three layers, two conductive layers and in-between an insulating layer, wherein said layers function as capacitor, wherein one outer layer serves as the positive charge and the second one with negative charge.

In accordance with some embodiments of the present invention the filter is sterilized at defined time periods by applying heat through the filter.

In accordance with some embodiments of the present invention the active filter device further comprising electrical control part comprising a resistor connected through electrical connection to an external energy source device.

In accordance with some embodiments of the present invention the active filter device is implemented in face mask.

### BRIEF DESCRIPTION OF THE DRAWINGS

The present invention will be more readily understood from the detailed description of embodiments thereof made in conjunction with the accompanying drawings of which:

FIG. 1 is an overview illustration of a block diagram of an air filter device having an external power source device, according to some embodiments of the invention;

FIG. 2 is an overview illustration of a block diagram of an air filtering device having an internal power source device, according to some embodiments of the invention;

FIG. 3A is an overview illustration of a block diagram of an air filter device charged with static electricity, according to some embodiments of the invention;

FIG. 3B is an overview illustration of a block diagram of an air filter with filter layer of chemicals and/or other agents' layer, according to some embodiments of the invention;

FIG. 3C is an overview illustration of a block diagram of an air filter with mesh of with metal material or impregnation of metal material layer, according to some embodiments of the invention;

FIG. 4 is an overview illustration of a block diagram of an air filtering system having a computing device, having a power source for controlling and monitor current and voltage, according to some embodiments of the invention;

FIG. 5 is an overview illustration of a block diagram of an air filtering system having a computing device as a power source using sensor at the filter device, according to some embodiments of the invention;

FIGS. 6A and 6B are an overview illustration of a flowcharts of filtering charging and/or operating and/or managing and controlling the filters, using mobile phone or other computer device, according to some embodiments of the invention;

FIG. 7 is an overview illustration of an air filtering mask, according to some embodiments of the invention;

FIG. 8 is an overview illustration of an air filtering mask, according to some embodiments of the invention;

FIG. 9 is an overview illustration of an air filtering mask functioning as capacitor, according to some embodiments of the invention;

FIGS. 10A, 10B, 10C, and 10D are overview illustrations of an air filtering mask layers, according to different embodiments of the invention;

FIG. 11A is an image of the filter made of LIG on non-woven fibrous, according to different embodiments of the invention, showing laser induced graphene fabricated (5 cm diameter) on non-woven fibrous surface uncoated P-84 (b) coated P-84 and (c) aramid needle surface;

FIG. 11B is an image of the filter made of LIG on non-woven fibrous, according to some embodiments of the invention, showing circular LIG filter (5 cm diameter) attached with copper wires attached with carbon glue on the surface of LIG;

FIG. 11C are microscopic images of the filter made of LIG on different types of non-woven fibrous, according to some embodiments of the invention, showing optical and microscopic image of coated P-84 (a, b) and LIG on it (c, d), optical and microscopic image of uncoated P-84 (e, f) and LIG on it (g, h) and optical and microscopic image of aramid needle (i, j) and LIG on it (k, l);

FIG. 12a is a block diagram of lab-in-built system for simulating the actual sneeze and cough environment, according to some embodiments of the invention, which comprises a schematic representation of lab-in-built system for simulating the actual sneeze and cough environment, where specifically, an agar plate was placed in between the spray tube, which can collect the highest frequency and counts of sprayed bacteria directly on the agar plate for CFU counting;

FIG. 12B is a block diagram of a scheme of bacteria killing with response of applied electricity, according to some embodiments of the invention, the scheme of bacteria killing with response of applied electricity, and where a small drop of bacteria solution was placed on LIG (fabricated on polyimide-PI surface) and incubated for 2-10 minutes with applied voltage 0-10 V;

FIG. 13 is a graph comparing performance of different material when using the filter in different configuration, according to some embodiments of the invention, showing bacteria passage of LIG coated uncoated P84, Coated P84 and aramid needle filters with and without applied electricity (2.5 V);

FIGS. 14a-14d are graphs showing different relation between parameters as tested, according to some embodiments of the invention, wherein FIG. 14a shows a I-V curve for C-P84-LIG and temperature increment with applied voltage, FIG. 14b shows power consumption of heating of C-P84-LIG as a function of temperature, FIG. 14c shows effect of squeezing/coughing on the C-P84-LIG filters, respective CFU counts collected on LB agar plate as a function of current (mA) and 14d shows CFU counts on dried and pre-cooled surface when bacteria sprayed circular LIG filters (5 cm diameter);

FIGS. 15a-15f according to some embodiment of the present invention show: FIG. 15a shows LIG is generated on C-P84 non woven fibrous material using a 10.6 μm CO₂ laser; FIG. 15b shows in i and iii—optical and microscopic images of surface structure of C-P84, ii—SEM image of the surface of C-P84, iv—microscopic image of C-P84-LIG which shows fibrous and porous nature; FIG. 15c shows SEM image of the C-P84-LIG, scale bar—200 μm; FIG. 15d shows Raman characterization of C-P84-LIG; FIG. 15e shows XPS broad spectrum survey of C-P84 and FIG. 15f shows pressure drop analysis of non-woven surface before and after making LIG on UC-P84 and C-P84;

FIGS. 16a-16f according to some embodiment of the present invention show: Bacteria killing assay using titanium plate (FIGS. 16a and 16b) and LIG on PI substrate (FIGS. 16c and 16d); effect of different resistance values of C-P84-LIG surface (FIG. 16e) on the killing of bacteria (FIG. 16f) at two different voltages (5.0 and 12.0 V);

FIGS. 17a-17c according to some embodiment of the present invention show: attachment of 4 cm×4 cm steel mesh on the surface of C-P84-LIG by carbon glue;

FIG. 17d shows average current and current density measurement of the system;

FIG. 17e shows CFU passed through this system;

FIGS. 18a-18c according to some embodiment of the present invention show optimization tables setting: FIG. 18A shows table A LIG optimization on coated P-84 surface using different settings of LIG instrument, FIG. 18B shows table B: LIG optimization on uncoated P-84 surface using different settings of LIG instrument, FIG. 18C shows table C: LIG optimization on Aramid needle surface using different settings of LIG instrument, FIG. 18D shows table D: Atomic % and maximum peak binding energy (eV) of different elements embedded in C-P84-LIG surface characterized by X-ray photo electron spectroscopy; and

FIGS. 19a-19c according to some embodiment of the present invention show effect of increased time exposure of electricity for counting the viable CTU on PI surface, wherein a 100% killing was found with 10 minute of electricity exposure, even at low current density/cm2.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways.

Also, it is to be understood that the phraseology and terminology employed herein is for the purpose of description and should not be regarded as limiting.

Electrically active air-filtration systems in homes, work, and public places, in flights, clean rooms, and in hospitals should be as energy efficient as possible, thus low voltage and low current bacterial killing are required. Electrical current has been demonstrated to inactivate bacteria and viruses in aqueous solutions using electrode configurations, 2-4 but less is known on the effect of current density on electrically conductive air filtration materials for bactericidal activity, in which joule heating effects are minimized.

The present invention provides an active air filter device for disrupting or destroying bacteria and/or viruses their toxins and other particles.

The filter may be made of at least one layer of a porous conductive material, for instance, carbon-based porous material such as LIG (Laser induced Graphene).

In accordance with some embodiments of the present invention, the filter device may comprise an energy source which creates current, or voltage or electromagnetic fields, or magnetic field that propagates through the porous conductive material. The energy source may be an internal part of the device or external part such as a battery, an electrical socket or a computer device that is electrically connected to the filter device.

According to other embodiments of the present invention an electromagnetic field may be created through the porous carbon based conductive material, as LIG.

According to some embodiments of the present invention, the porous conductive carbon-based material is made of one sided or two sides or more layers, creating a 3D design which enables trapping the bacteria and/or viruses and/or other particles within the porous material.

According to other embodiments of the present invention, the porous conductive carbon-based material may be integrated with other active or passive layers of other materials such as polyester fibre (non-wetting), standard air filter. Chemical/Chemically as impregnated material by Antibiotics, Alcohol, Chlorhexidine, Iodine, or Metal-based material or Materials Impregnated with metal, such as cooper and/or silver, and/or lead.

Once bacteria and/or virus, their toxins and/or other particles are trapped within the air filter, the voltage charge targets and eliminates thereof. Such active solution maintains the filter continuously uninfected as the bacteria and/or viruses are continuously being trapped and destroyed via the voltage charge.

The energy source may be control manually by the user or automatically by a control module, which may be implemented as a management application on a mobile phone or other computer.

According to some embodiments of the present invention, the current emerging from the energy source may be either a direct current or an alternating current, continuously, or intermittently at a given time and/or its form may be electric pulses of various shapes. According to other embodiments, the current may be pulsed in predefined cycles or according to predefined rules. The predefined rules may be based on the condition of the filter by sensing the cleanliness of the filter is or if bacteria or virus where detected on the filter.

In accordance with some embodiments of the present invention, the condition of the filter may be tested using internal or external sensors such as conductivity sensors, light sensors, ultrasound sensors, patency sensors, chemical indicators, fluorescent materials and the like.

According to some embodiments of the present invention, the sensing data received may indicate the presence of bacteria and/or virus and may be used to send to other user(s) in a nearby area warning messages alerting them to use the active masks.

According to some embodiments of the present invention the filter materials may include bacteriocides material(s) such as metals (e.g., copper, silver, lead, etc.) and/or chemicals such as antibiotics, alcohol etc. This material may be used at one or more layer and/or at the layer in which the current is induced or may be applied at a different layer of the filter.

According to other embodiments of the present invention a static electricity may be created via the porous material. In this case, an external power source may not be required. In accordance with some embodiments of the present invention, the static electricity may be a pre-set of the material or may emerge by the user, by rubbing the outside surface of the filter or by inner layers designed to be movably interconnected.

According to some embodiments, the filter may be used as face mask having a USB connector to a smart phone or other computer device.

According to other embodiments the air filter may be used for a rooms air filtering independent device or as part of an air-condition system, in buildings, vehicles (cars, aircraft, boats) and such. The filter may be integrated as part of an existing air-condition systems as inner or external parts.

According to some embodiments of the present invention the filter may comprise three layers, two conductive layers and in-between an insulating laser. Such filters functions as capacitor. One outer layer serves as the positive charge and the second one with negative charge. Once bacteria and/or virus, their toxins and/or other particles are trapped within the inner layer, they are closing the circuit between the outer layers, hence a current is passing through the any type of particle which is conductive, hence the bacteria and/or virus, their toxins are destroyed.

According to some embodiments of the present invention the filter may be sterilized at defined time periods such as the end of the day, by applying heat through the filter.

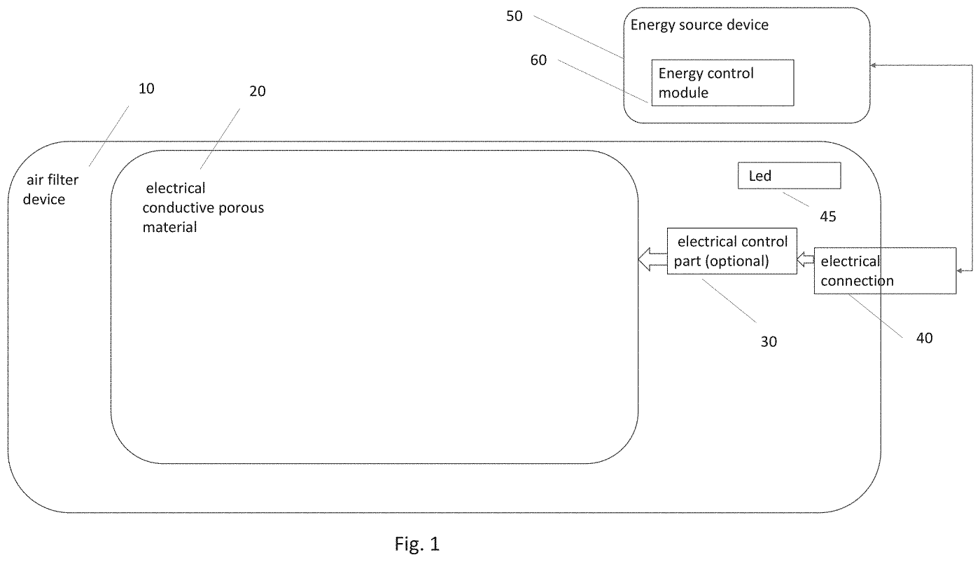

FIG. 1 is an overview illustration of a block diagram of a filtering device having an external power source device according to some embodiments of the invention.

The present invention is using a Laser-induced graphene (LIG), this technology is uniquely positioned to advance applications where electrically conductive carbon coatings are required. Recently, LIG has been demonstrated in both air and water filtration, and anti-fouling, anti-viral, and anti-bacterial properties were observed. The applicant found that for the purpose the air filtration, an unsupported LIG based filter with pore size of ca. 0.3 micron provide exceptional filtration properties and joule heating effectively sterilized and removed biological components, (although pressure drop, energy consumption and mechanical robustness could be improved). The present invention suggested using a polyimide non-woven supported LIG air filter which support low electrical current density inactivates bacteria. At the testing the LIG did not negatively affect the pressure drop of the non-woven filter material. The testing showed that compared to the non-woven PI substrate, the LIG coating only improved filtration of aerosolized P. aeruginosa by ˜10%, however, application of 15-20 V increased bacterial removal by ˜14 fold compared to the non-woven PI substrate alone. Without heating the substrate, a current density of ˜8 mA cm⁻² for 2 minutes was capable to completely sterilize the surface and only ˜6 mA cm⁻² was required if the current was applied for 10 minutes.

According to some embodiments of the present invention, the low voltage bacterial killing mechanism of action was investigated and bacterial inhibition experiments using titanium surfaces or LIG surfaces fabricated on dense PI films both indicated that low current density levels on the surface leads to bacterial death. Thus, a LIG-stainless steel mesh hybrid filter could effectively remove ˜99% bacteria, using only ˜3 V. Thus, these electrically active air filters are poised to be effectively used in a wide number of air filtration applications such as air-conditioners or other ventilation systems and might limit the spread of infectious particles in hospitals, homes, workplaces and in the transportation industry.

Laser induced graphene (LIG) fabrication methods produces a porous electrically conductive coating on many types of polymer surfaces and has been demonstrated to be useful in many applications. Its application on surfaces and water filters demonstrated voltage dependent antimicrobial and artibiofouling effects, and Stanford et al. demonstrated a self-cleaning, air filter comprised of laser-induced graphene (LIG) that was shown to capture particulates and inactivate bacteria through a joule heating step. However, low mechanical robustness, and the fabrication steps might lead to challenges in up-scaling and commercialization of such a configuration.

The present invention suggests using fabricated LIG on non-woven polyimide fabric, which not only results in a simple, robust active air filter, but based on testing conduct by the applicant support a low current density is sufficient for bacterial inactivation. This electrical killing effect of the LIG as suggested by the present invention is combination of fabricated LIG with the depth filtration effect, inertial impaction, interception and electrostatic attraction particle filtration which are all effects of the non-woven support leading to an overall enhanced effect for bacterial removal from the air. In the applicant test study, was used a commercially available PTFE coated P84 non-woven material and optimized the laser power, scan speed and PPI for LIG preparation. Parameters that resulted in LIG with least damage to the non-woven material with low electrical resistance were used in air filtration experiments with aerosolized P. aeruginosa. The bacterial removal efficiency depended on the surface current density and this mechanism was confirmed using titanium surfaces and LIG on dense polyimide films. The filter configuration was ultimately improved by attaching a stainless steel mesh to the LIG filter and ˜99% bacteria was removed at very low voltages (—0.3 V). This micro porous LIG filter gave a low pressure drop and can be easily up scaled and applied to air-purification systems.

Contagion of disease via infectious aerosols can be limited with highly effective air filtration. The present invention optimized the porous electrically conductive LIG on non-woven air filters for effective antibacterial filtration of aerosols. Although Joule heating effects can inactivate bacteria as shown earlier, (shown in Stanford article) the applicant has observed that current density plays an important role in bacterial inactivation and removal efficiency. A low energy LIG-SS hybrid air filter was thus designed and showed effective bacterial removal at very low voltages. These designs enable highly effective low cost air filtration solutions especially in public places such as hospitals where airborne pathogens present a high health risk especially for immunocompromised patients.

According to this embodiment the air filter device 10 is comprised of electrically conductive porous material 20, electrical control part such as a resistor (optional) 30 connected through electrical connection 40 to an external energy source device 50 such as computer device or a mobile phone which may include an energy control module 60. The filter device may further include an indicator such as LED 45 which may indicates when the filter is active.

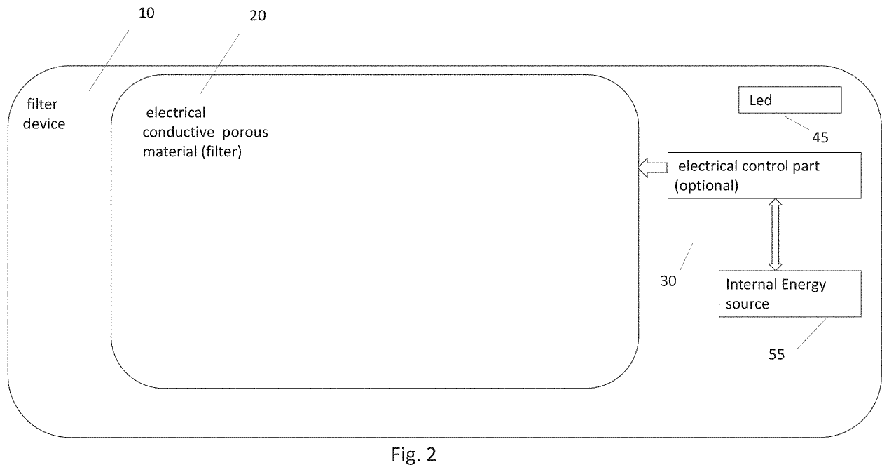

FIG. 2 is an overview illustration of a block diagram of the air filter device having an internal power source device according to some embodiments of the invention.

According to this embodiment, the air filter device 10 is comprised of electrically conductive porous material (filter) 20, electrical control part 30 connected to an internal energy source 55. The filter device may further include an indicator such as LED 45 which may indicates when the filter is active. The filter device 10 may further include power and/or control buttons enabling the user to control the activation of the air filter device.

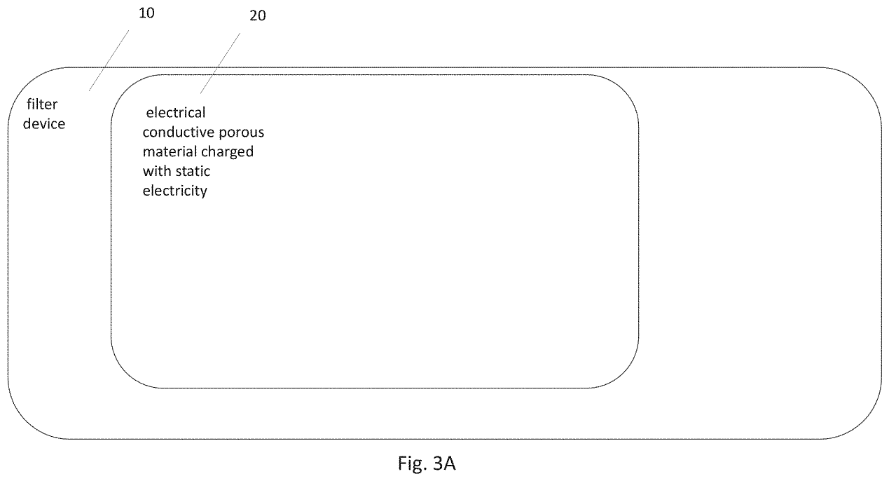

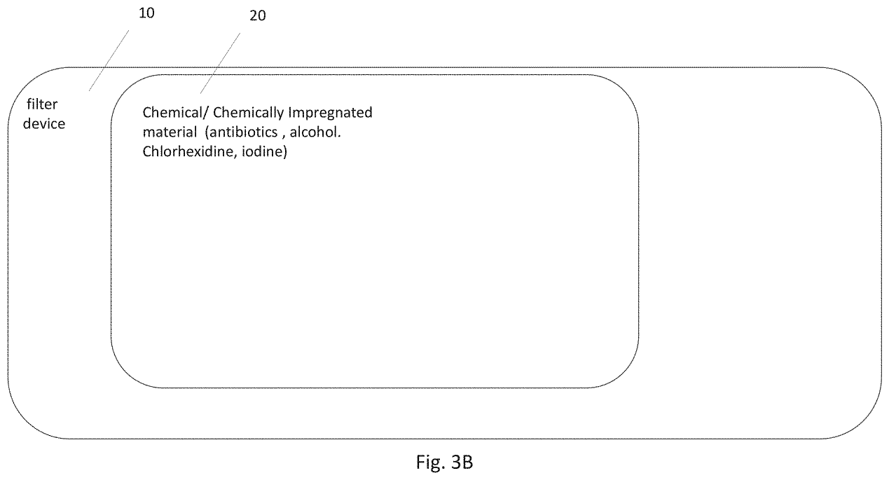

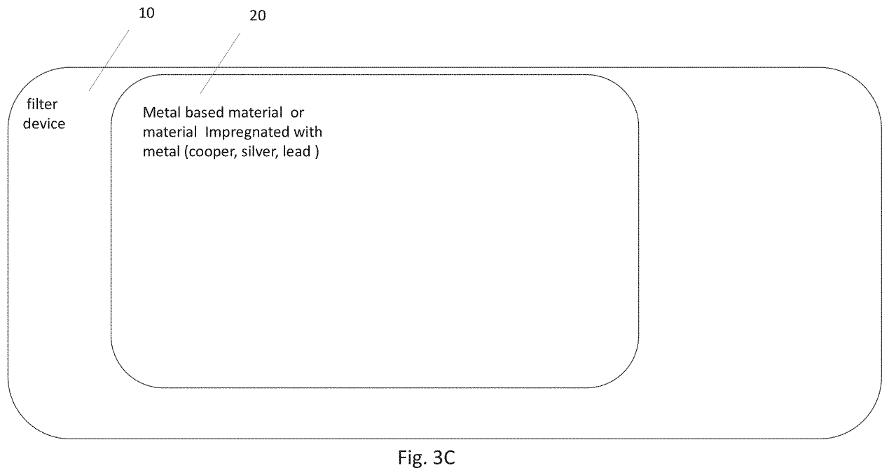

FIG. 3A is an overview illustration of a block diagram of filtering device based on static electricity mechanism, according to some embodiments of the invention.

According to this embodiment, the air filter device 10 is comprised of electrically conductive porous material charged with static electricity 20 and static electricity mechanism. In this case, power source is not required, and the static electricity is emerging when the user contacting the outer surface of the filter or by inner layers designed to be movably interconnected, as an option to charge the material with static electricity.

FIG. 3B is an overview illustration of a block diagram of an air filter chemical layer, according to some embodiments of the invention.

FIG. 3C is an overview illustration of a block diagram of an air filter metal layer, according to some embodiments of the invention.

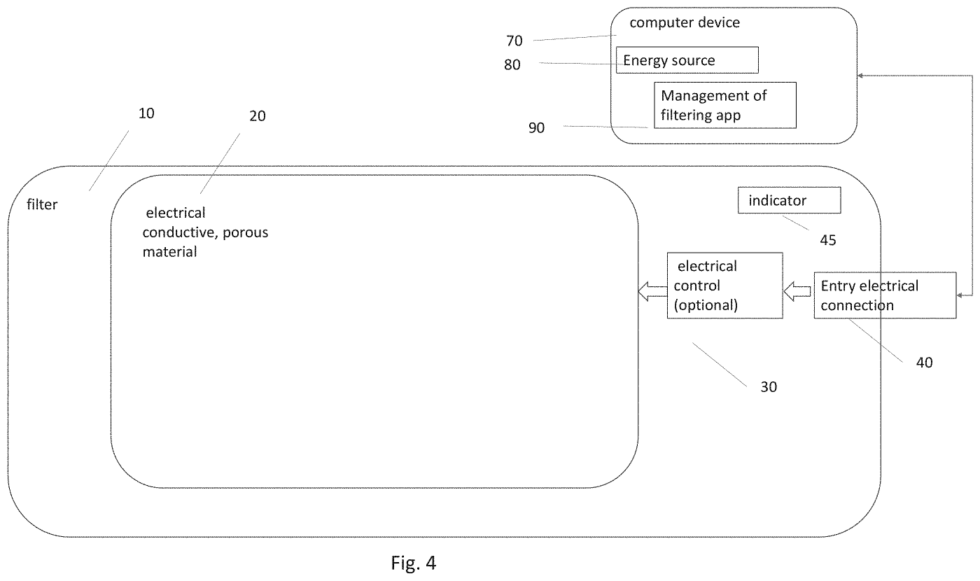

FIG. 4 is an overview illustration of a block diagram of a filtering device having a computing device as power source and management according to some embodiments of the invention. According to this embodiment the air filter 10 is comprised of electrically conductive porous material 20, electrical control (optional) 30 connected through entry electrical connection 40 to a computer device, which includes energy source 80 and management of filtering application 90. The air filter device may further include an indicator 45 such as LED which may indicate when the filter is active.

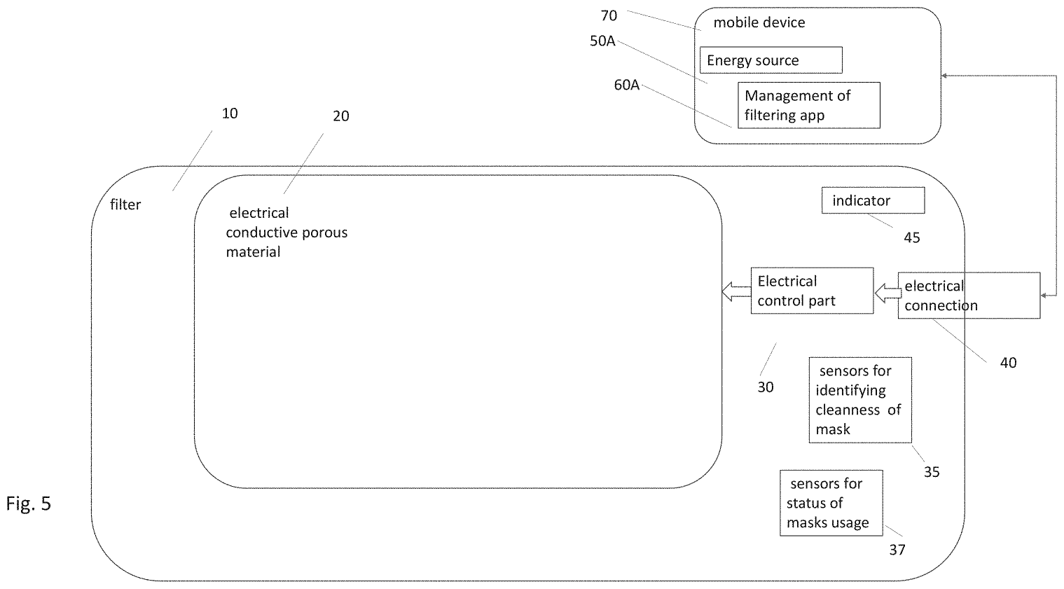

FIG. 5 is an overview illustration of a block diagram of an air filtering device having a computing device as power source using sensor at the filtering device according to some embodiments of the invention.

According to this embodiment the air filter 10 is comprised of electrically conductive porous material 20, electrical control part 30 connected through electrical connection 40 to a computer device or a mobile phone, which includes energy power source 50A, a management application 60A for filter activation.

The filter device may further include sensors for identifying patency or cleanness of mask filter 35 or detecting bacteria's or virus within the filter.

The filter device may further include sensors for status of masks usage 37 for checking the usage condition of the filter to estimate if the mask should be replaced.

The filter device may further include an indicator 45 such as LED which indicates when the filter is active.

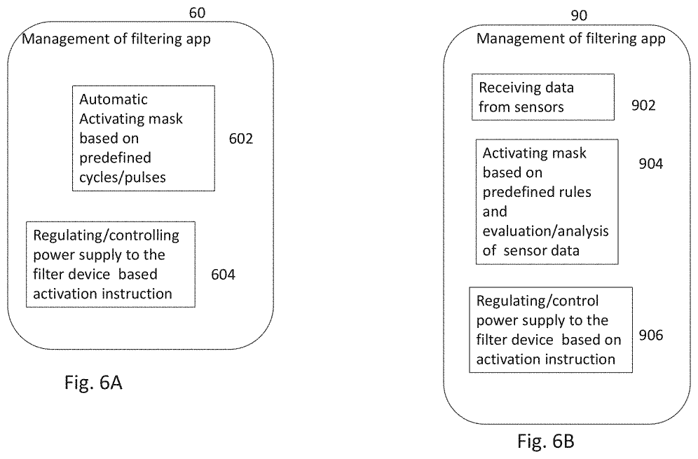

Each of FIGS. 6A, 6B is an overview illustration of a flowchart of filtering management application, according to sonic embodiments of the invention.

According to the embodiment of FIG. 6A, the automatic activation of a mask is controlled according to predefined cycles defining activation instruction enabling continuous activation or pulses activation at predefined times period (step 602). Based on activation instruction the power supply to the filter device is regulated (step 604).

According to the embodiment of FIG. 6B, the automatic activation of a mask is controlled according to predefine rules, defining activation instruction enabling continuous activation or activation at predefined times based on analyzing data received from the sensors (step 902, 904). Based on activation instruction, regulating the power supply to the filter device (step 906).

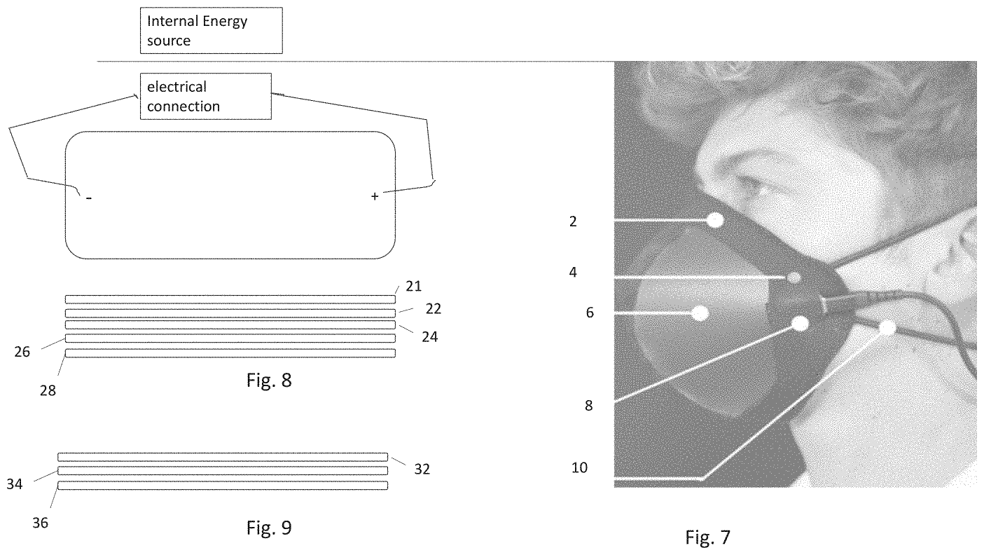

FIG. 7 is an overview illustration of an air filtering mask, according to some embodiments of the invention.

FIG. 8 is an overview illustration of an air filtering mask, according to some embodiments of the invention.

The mask may be comprised of several layers such as non-wetting material (as polyester fiber) (21 and 28) (inner and outer layer), standard filter with N95 features (22), conductive porous material layer (such as activated charcoal or graphene) (24), Chemical or chemically Impregnated material layer (26) (such as antibiotics, alcohol, chlorhexidine, iodine) or metal based material, or material impregnated with metal layer (as cooper, or silver, or lead)) (26).

FIG. 9 is an overview illustration of an air filtering mask functioning as capacitor, according to some embodiments of the invention.

The mask may be comprised of three layers: first outer layer (32), made of conductive porous having positive charge, inner insulating layer made of porous material (34) and third layer 36 made of conductive material having negative charge. In this filter configuration, the filter functions as capacitor, hence trapped conductive particle are activated as conductive substance, connecting between the positive and negative charges of the outer layers 32 and 36. Hence when current is passing through the any type of particle which is conductive, hence the bacteria and/or virus, their toxins are destroyed.

The close-knit fabric mask 2 comprises: a filter made of porous carbon-based conductive materials 6 such as Graphene, USB port 8 for electrically connecting to computing device such as a mobile phone or standard power bank deice, Power cord connected to USB port, flexible one size band 10 and Led indicator 4. Within the mask is integrated module for controlling an electric current (not seen in this figure).

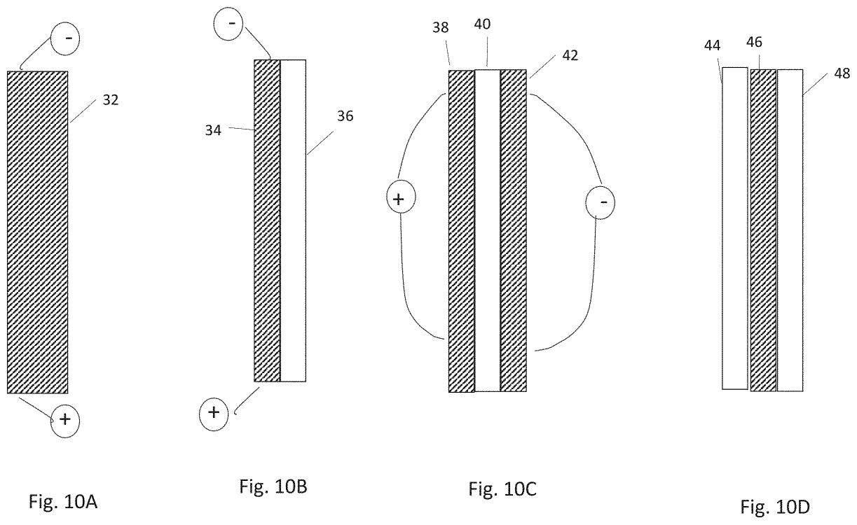

FIGS. 10A, 10B, 10C, and 10D are overview illustrations of an air filtering mask layers, according to different embodiments of the invention.

According to FIG. 10A, the filter layer includes full LIG 32, results of processing (inducing laser) of both sides membrane. The LIG layer is connected on one side to positive charge and on the other side to negative charge.

According to FIG. 10B, the filter layer includes partial LIG layer, comprising one part 34 made of LIG and a second part non induced membrane 36, results of processing (inducing laser) of one side of the membrane. The LIG layer part is connected on one side to positive charge and on the other side to negative charge.

According to FIG. 10C, the filter layer includes partial LIG layer, comprising one part 38 made of LIG, a second inner part layer made of non-induced insulating membrane 40 and third part made of LIG layer, results of processing (inducing laser) of two side of the membrane, while maintaining an inner layer non induced. The first LIG layer part is connected to positive charge and on the third part to negative charge.

According to FIG. 10D, the filter layer includes partial LIG layer, comprising one inner part layer 46 made of LIG and two outer layers made of membrane 44. The LIG layer part is connected on one side to positive charge and on the other side to negative charge.

The filter may be combination of LIG layers and membrane integrated of different order/arrangement.

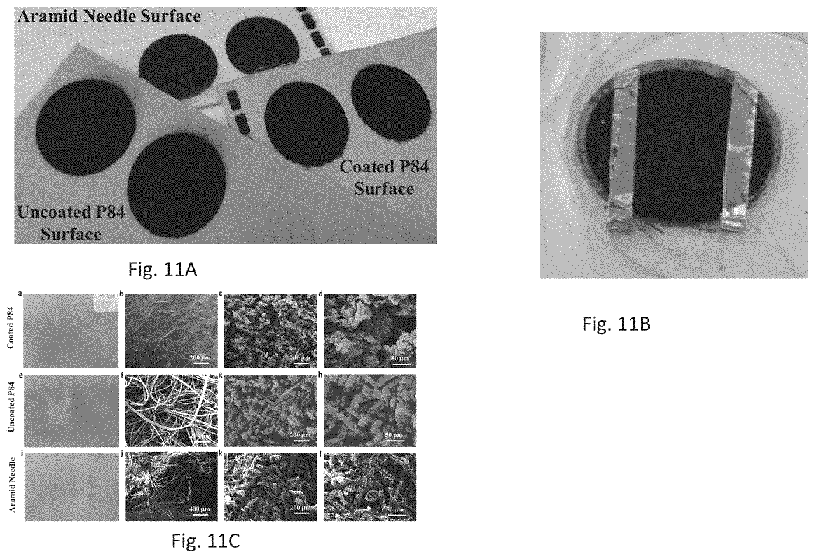

FIG. 11A is an image of the filter made of LIG on non-woven fibrous, according to different embodiments of the invention.

Laser induced graphene is shown fabricated (5 cm diameter) on non-woven fibrous surface (a) uncoated P-84 (h) coated P-84 and (c) aramid needle surface.

FIG. 11B is an image of the filter made of LIG on non-woven fibrous, according to some embodiments of the invention.

Circular LIG filter (5 cm diameter) is shown attached with copper wires attached with carbon glue on the surface of LIG.

FIGS. 11C are microscopic images of the filter made of LIG on different types of non-woven fibrous, according to some embodiments of the invention.

Optical and microscopic images are shown of coated P-84 (a, b) and LIG on it (c, d), optical and microscopic image of uncoated P-84 (e, f) and LIG on it (g, h) and optical and microscopic image of aramid needle (i, j) and LIG on it (k, l).

FIG. 12a is a block diagram of lab-in-built system for simulating the actual sneeze and cough environment., according to some embodiments of the invention.

FIG. 12A shows a schematic representation of lab-in-built system for simulating the actual sneeze and cough environment. Specifically, an agar plate was placed in between the spray tube, which can collect the highest frequency and counts of sprayed bacteria directly on the agar plate for CFU counting.

FIG. 12B is a block diagram of a scheme of bacteria killing with response of applied electricity, according to some embodiments of the invention.

Scheme of bacteria killing with response of applied electricity. Here a small drop of bacteria solution was placed on LIG (fabricated on polyimide-PI surface) and incubated for 2-10 minutes with applied voltage 0-10 V.

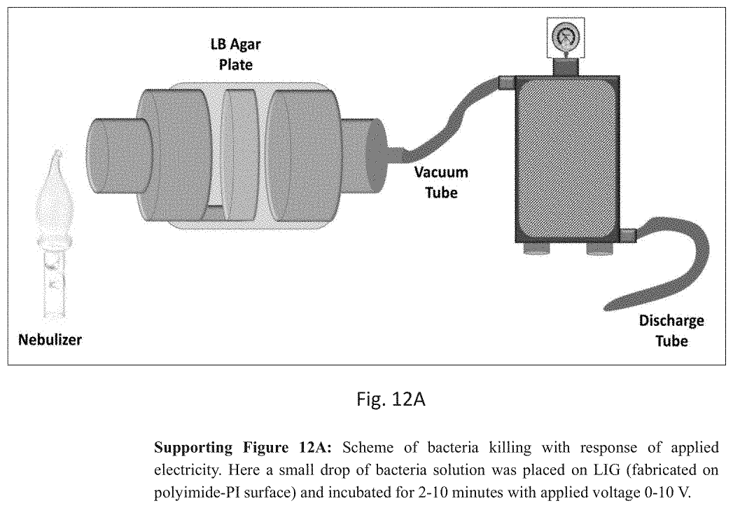

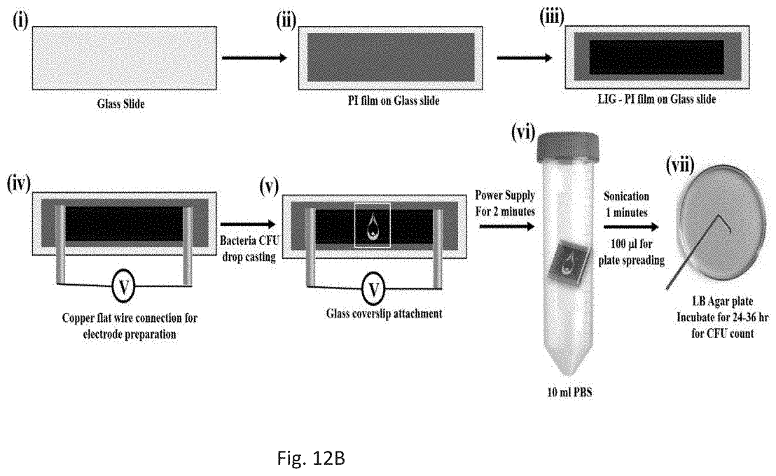

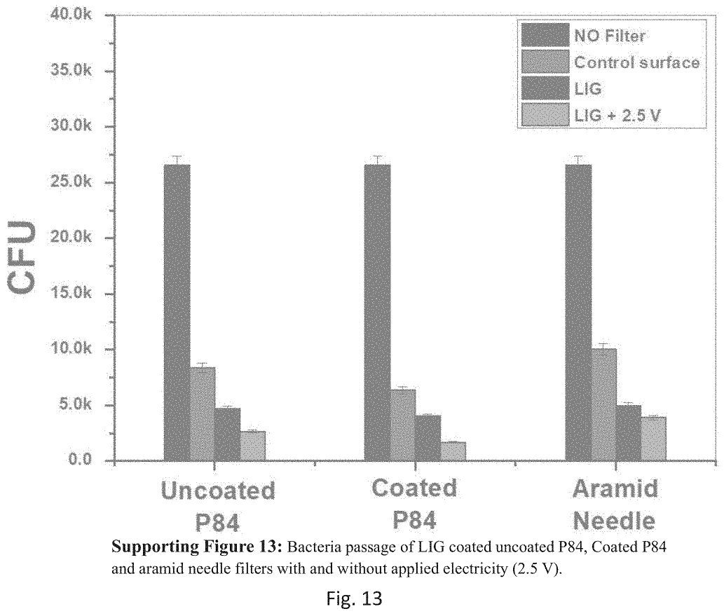

FIG. 13 is a graph comparing performance of different material when using the filter in different configuration, according to some embodiments of the invention.

Bacteria passage of LIG coated uncoated P84, Coated P84 and aramid needle filters with and without applied electricity (2.5 V).

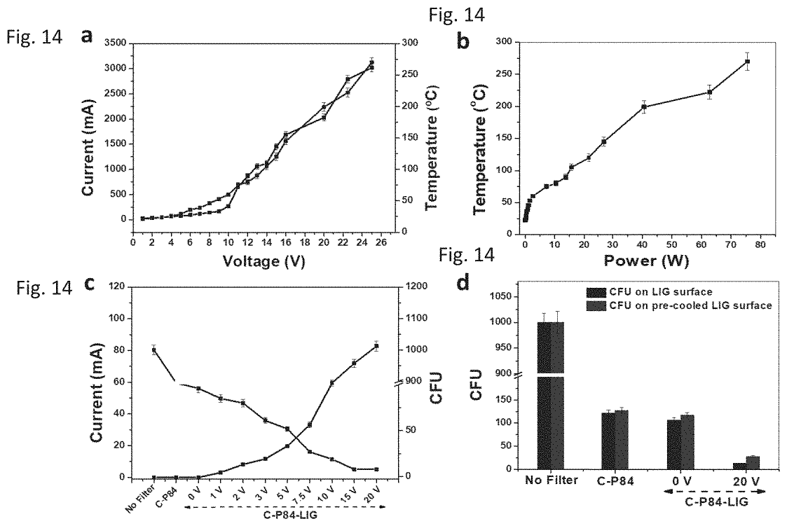

FIGS. 14a-14d are graphs showing different relation between parameters as tested, according to some embodiments of the invention.

FIG. 14a is a I-V curve for C-P84-LIG and temperature increment with applied voltage, FIG. 14b shows power consumption of heating of C-P84-LIG as a function of temperature, FIG. 14c shows effect of squeezing/coughing on the C-P84-LIG filters, respective CFU counts collected on LB agar plate as a function of current (mA) and FIG. 14d shows CFU counts on dried and pre-cooled surface when bacteria sprayed circular LIG fillers (5 cm diameter).

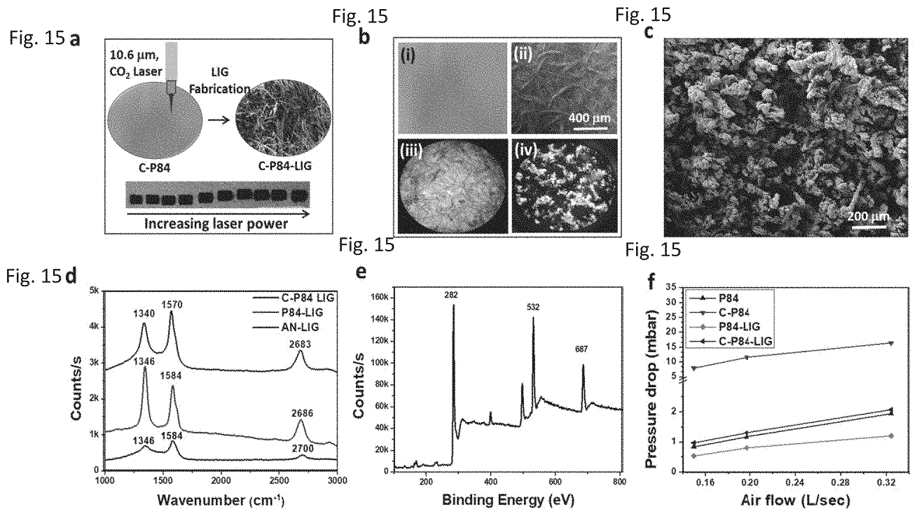

FIGS. 15a-15f according to some embodiment of the present invention show: FIG. 15a shows LIG is generated on C-P84 non-woven fibrous material using a 10.6 μm CO2 laser; FIG. 15b shows i, iii—optical and microscopic images of surface structure of C-P84, ii—SEM image of the surface of C-P84, iv—microscopic image of C-P84-LIG which shows fibrous and porous nature, FIG. 15c shows SEM image of the C-P84-LIG, scale bar—200 μm, FIG. 15d shows Raman characterization of C-P84-LIG, FIG. 15e shows XPS broad spectrum survey of C-P84, and FIG. 15f shows pressure drop analysis of non-woven surface before and after making LIG on UC-P84 and C-P84.

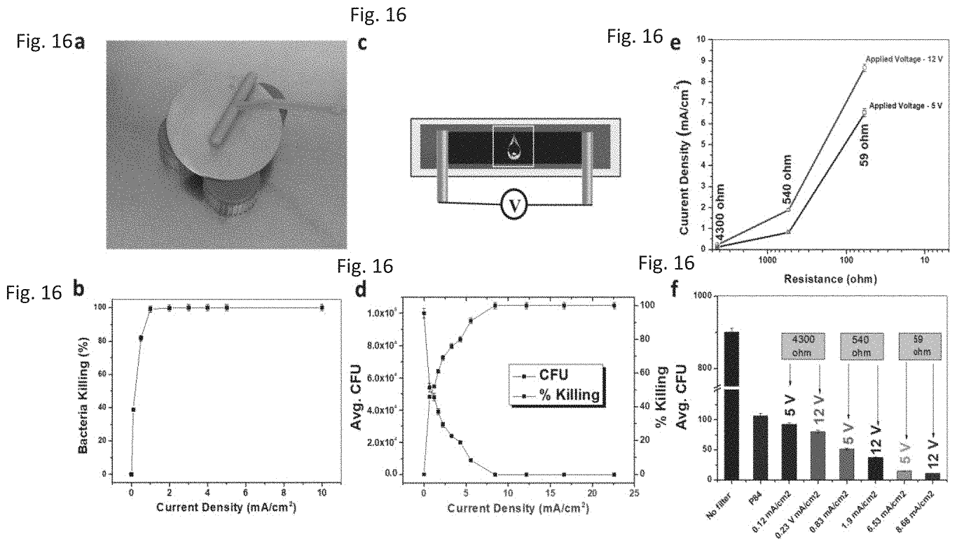

FIGS. 16a-16f according to some embodiment of the present invention show: Bacteria killing assay using titanium plate (FIGS. 16a and 16b) and LIG on PI substrate (FIGS. 16c and 16d). Effect of different resistance values of C-P84-LIG surface, FIG. 16e shows on the killing of bacteria (FIG. 16f) at two different voltages (5.0 and 12.0 V).

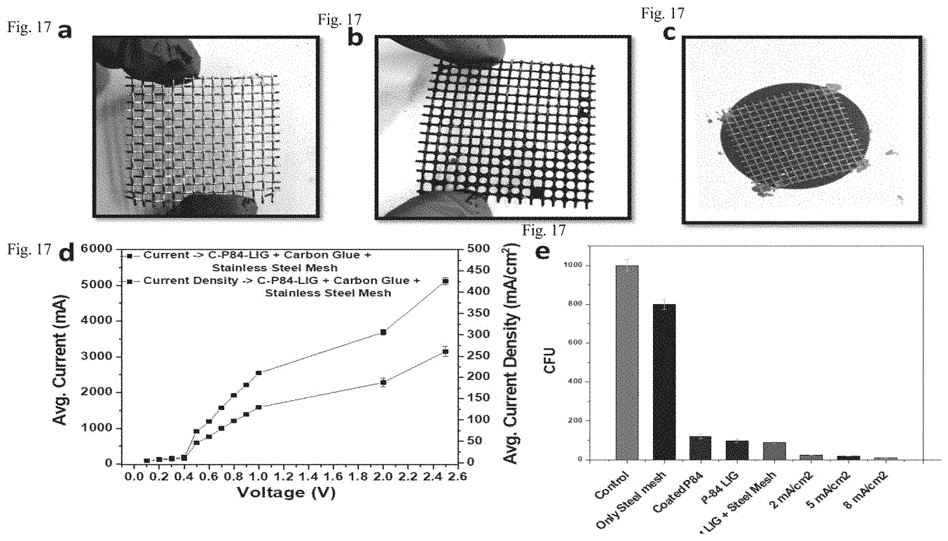

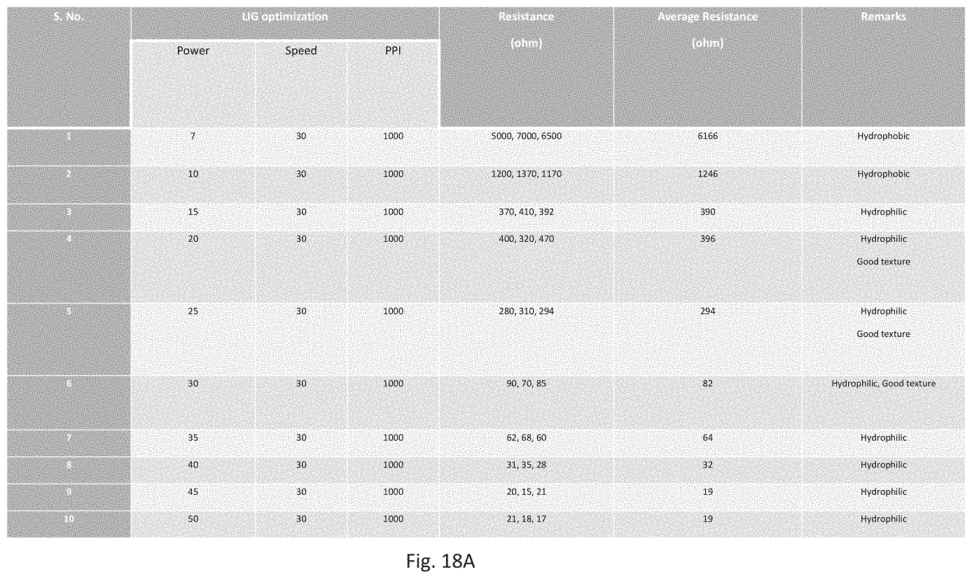

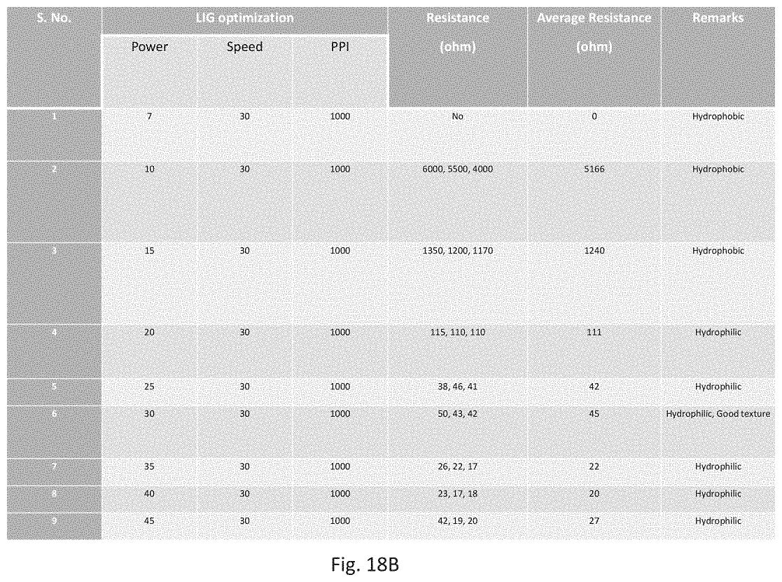

FIGS. 17a-17c according to some embodiment of the present invention show: attachment of 4 cm×4 cm steel mesh on the surface of C-P84-LIG by carbon glue. FIG. 17d show average current and current density measurement of the system, and FIG. 17e shows CFU passed through this system.

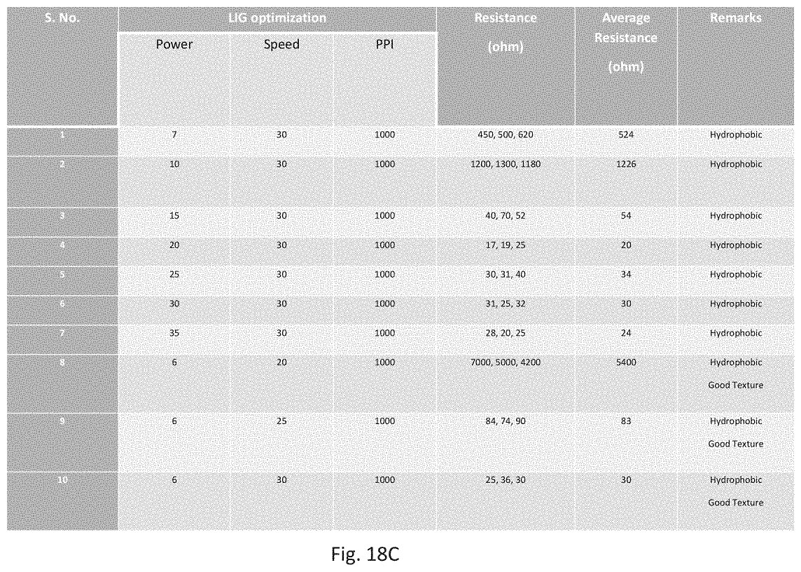

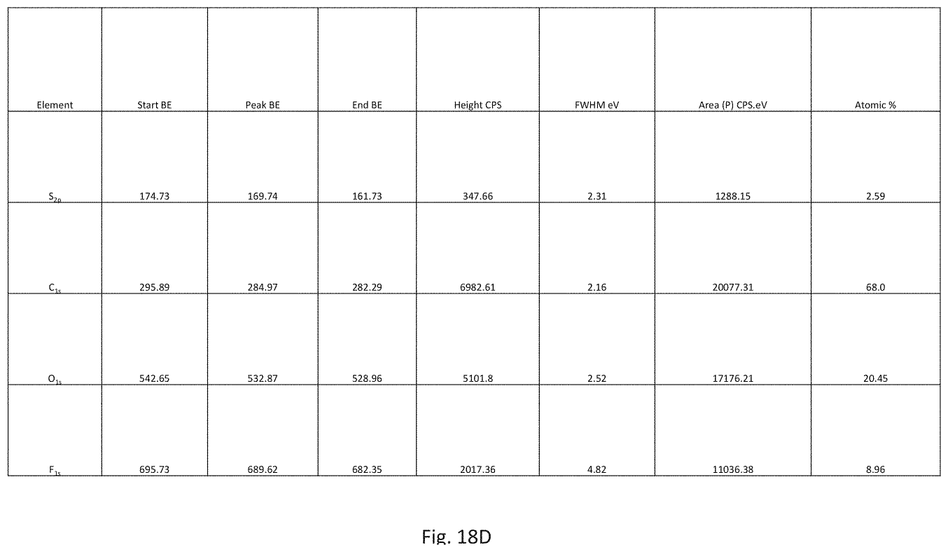

FIGS. 18a-18c according to some embodiment of the present invention show optimization tables setting: FIG. 18A is table A showing LIG optimization on coated P-84 surface using different settings of LIG instrument, FIG. 18B is table B showing LIG optimization on uncoated P-84 surface using different settings of LIG instrument, FIG. 18C is table C showing LIG optimization on Aramid needle surface using different settings of LIG instrument, FIG. 18D is table D showing Atomic % and maximum peak binding energy (eV) of different elements embedded in C-P84-LIG surface characterized by X-ray photo electron spectroscopy.

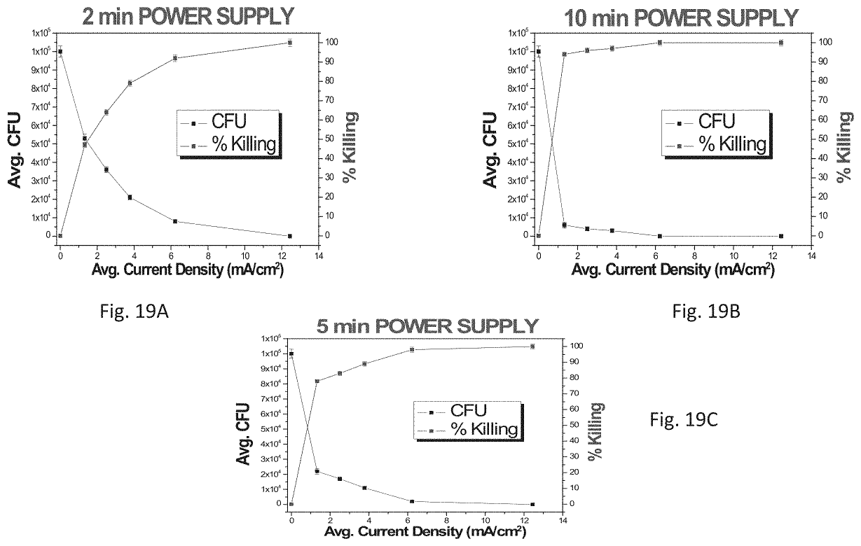

FIGS. 19a-19c according to some embodiment of the present invention show effect of increased time exposure of electricity for counting the viable CFU on PI surface. A 100% killing was found with 10 minute of electricity exposure, even at low current density/cm2.

The mask Advantages:

1) The mask may have multi step process to tackle bacteria, viruses, toxins and particles.

2) It may actively capture and destroy them.

3) It may operate its active operation due to electricity and/or heat and/or chemical effects.

4) It may be used multiple times.

5) It does not lose its usability if moist.

6) It actively defends against multiple breathing challenges.

7) It provides a solution for pollution as well as biological contaminants.

8) Unlike other masks that become contaminated, the mask according to the present invention can be is easily sterilized.

9) The mask is an affordable solution for multiple pollution scenarios including pollution and biological contaminants.

The polyimide non-woven supported LIG air filter as suggested by the present invention showed that low electrical current density inactivates bacteria. The LIG did not negatively affect the pressure drop of the non-woven filter material. Compared to the non-woven PI substrate, the LIG coating only improved filtration of aerosolized P. aeruginosa by ˜10%, however, application of 15-20 V increased bacterial removal by ˜14 fold compared to the non-woven PI substrate alone. Without heating the substrate, a current density of ˜8 mA cm−2 for 2 minutes was capable to completely sterilize the surface and only ˜6 mA cm−2 was required if the current was applied for 10 minutes.

According to the applicant testing, LIG surfaces fabricated on dense PI films both indicated that low current density levels on the surface leads to bacterial death.

According to other embodiments of the present invention, it is suggested for low voltage bacterial killing mechanism may be achieved using titanium surfaces.

Non-woven materials were used to fabricate LIG. These materials may include polyimide based non-woven substrate (P84), a PTFE coated P84 non-woven substrate (C-P84) and an aromatic polyimide (Aramid) non-woven substrate (AN). The fabrication of LIG was accomplished using a CO2 laser at ambient atmosphere and the laser power and the scanning speed were varied. As the laser power increased the electrical resistance of the surface decreased however a deeper ablation was seen on the substrate and melting of fibers on the backside was seen at the highest power setting. Thus, optimized settings were chosen that took into account an intact nonwoven substrate with a uniform LIG surface texture with a low electrical resistance LIG could be achieved on each substrate and similar electrical resistance, pressure drop, and surface texture were observed for each substrate. However, the lowest bacterial passage was observed for LIG coated C-P84 filters in preliminary bacterial filtration and detailed study and characterization was performed on the C-P84-LIG filters.

Experimental Section

Materials:

Non-woven needle felt P84 material (with and without PTFE coating) and Aramid needle with a thickness of 2.7 mm were purchased from Hangzhou Hengke Filter Environmental Protection Co., Qianjiang, Hangzhou China. Sodium chloride (NaCl, 99%), sodium phosphate dibasic heptahydrate (Na2HPO4·7H2O>99%), monobasic potassium phosphate (KH2PO4, 99%), potassium chloride (KCl), were used for the preparation of phosphate buffered saline (PBS). GN-6 Metricel® MCE Membrane Disc Filters—50 mm, grid purchased for collection of bacteria in the filtration system. In-house construction of air-filter test apparatus included a magnetic filtration funnel and a variable speed Buchi V-700 vacuum pump with controller. A Milli-Q ultrapure water purification system (Millipore, Billerica, Mass., USA) was used for deionized (DI) water.

LIG Fabrication:

LIG was generated on non-woven needle felt filters (P84 with and without PTFE coating, and Aramid) using a Universal Laser Systems laser platform (VLS3.50), equipped with a 10.6 μm CO2 pulsed laser (50 W). For optimization, areas of 1 cm2 were lased using variable power (6 to 50%) and scan rate (20 to 30%) and image density was set to 1000 pulses per inch (PPI). Samples were compared by measuring the electrical resistance of the surfaces using a multimeter. Circular LIG coatings (d=5 cm) on tested air filters were made using 30% power, (30%) scan rate and image density set to 1000 PPI. A nozzle provided with the instrument was used to blow air toward the laser spot, while the general atmosphere within the laser platform was still air at ambient pressure at rt. The adhesive of two pieces of copper tape was removed using acetone, and the copper foil was attached to the LIG surface in parallel separated by a distance of 36 mm using conductive carbon glue. Epoxy adhesive was applied on top of the copper and was connected to the DC power supply (voltage: 0-30 V) using alligator clips. Current was measured using a multimeter connected in series to the power supply and the surface temperature was monitored using an IR temperature gun (model—CPS, TEMP SEEKER-TMINI12). Current, voltage, and joule heating effects were measured separately on 2 cm×2 cm LIG fabricated with the same settings. Power was calculated using P=V.I, where P is power, V is voltage, and I is current. Electrical resistance of the LIG surfaces (1 cm2) was measured with a multimeter (Uni-T ut33) at rt, and the average value of at least three measurements was reported. For fabrication of LIG with variable resistances, LIG coatings (d=5 cm) were made on PTFE coated P84 non-woven needle felt filters with 4, 8 and 15% power (1000 PPL 30% scan speed). For LIG-stainless steel hybrid filter, a stainless steel mesh (4 cm×4 cm, SS304, industry standard woven mesh 10, 1.905 mm aperture) was dip coated in conductive carbon glue. The excess carbon glue was removed by shaking the drops out the mesh before attaching to the LIG surface and dried for 2 h.

Bacteria Preparation:

P. aeruginosa (PAO1) was grown in Luria-Bertani (LB) broth at 30° C. and harvested in mid-exponential phase, which was verified by measuring the optical density at 600 nm. The bacterial cells were further diluted to ˜1×105 colony-forming units (CFU) in sterile PBS solution. The bacteria were aerosolized using glassware connected to a manual handpump that sprayed 70 □L of the liquid bacterial culture for each experiment. The bacteria CFU were enumerated using the plate counting method.

Air Filtration Test System:

We custom built apparatus such that the bacteria aerosol was sprayed through a 24 cm long plastic tube (d=12 cm) in which the filter was mounted at the end of the tube on a mounting plate with a 36 mm hole (FIG. 12A). A sterile agar plate was mounted 2 cm behind the filter. A vacuum was connected to the system such that air was drawn through the filter. A 45 micron membrane filter was placed between the test system and the vacuum pump to prevent bacteria from entering the vacuum pump. The spray chamber was washed with 70% ethanol before and after each experiment. After the apparatus was assembled, the vacuum pump was turned on, a voltage (0-30 V) was applied to the filter, and the bacteria solution was sprayed at the filter. After 2 min the vacuum pump was turned off, and the bacterial solution that was collected on the agar plate was spread with a sterile plastic loop and incubated for 24 hours at 30° C. At high voltages, heating of the filter surface was observed, thus the filter surface was cooled to r.t. by spraying 70-140 μL sterile DI before the bacteria solution was sprayed at the filter. Pressure drop was measured using an LCD Digital Manometer—Air Pressure Meters Gauge 12 Unit Tester by passing air through the falter mounted in a magnetic filtration funnel.

Bacteria Killing on Titanium and LIG:

A solution of P. aeruginosa in sterile saline (0.9% NaCl, 50 □L, 5×104 CFU) was spread on a pre-sterilized titanium disk (d=4.6 cm) and incubated for 2 min with variable current density (0-10.0 mA cm−2) using an electrochemical workstation (Biologic SP-50). The disk was then immersed in sterile saline (10 mL) and sonicated (1 min), and the CFU were enumerated using the plate count method. For LIG, P. aeruginosa (20 μL, 106 CFU) was dropped on LIG (1 cm×4 cm) that was fabricated polyimide (PI) substrate as previously described and attached to a glass microscope slide. The bacterial solution was covered with a sterile glass coverslip 0-20.0 V was applied and incubated for 2-10 min. The surface was immersed in PBS (10 mL) and sonicated (1 min), after which 100 μL was spread on LB agar plate and the CFU were enumerated using the plate count method.

Raman Spectroscopy:

The Raman system comprised a Horiba LabRam HR evolution micro-Raman system, equipped with a Synapse Open Electrode CCD detector air-cooled to −60° C. The excitation source was a 532 nm laser with a power on the sample of 0.5 mW. The laser was focused on LIG with an × 50 objective to a spot of about 2 μm. The measurements were taken with a 600 g mm−1 grating and a 100 μm confocal microscope hole. Typical exposure time was 30 seconds.

Scanning Electron Microscopy (SEM) Imaging:

Samples (0.5 cm×0.25 cm) were mounted horizontally or vertically for cross-section view on a circular aluminum stub using carbon tape. The samples were not coated with gold because the LIG sample was conductive in nature. The surface analysis and elemental mapping (EDS) was performed using a FEI JEOL IT 200.

X-Ray Photoelectronspectroscopy (XPS):

The XPS spectrometer ESCALAB 250 (Thermo Fisher Scientific, Waltham, Mass.) with an ultrahigh vacuum (10-9 bar), installed with an AlKα X-ray source (beam size: 500 μm) and a monochromator, was used. The signals from C₁ₛ, O₁ₛ, and S₂ₚ were detected by fixing different separated elements to the experimental data. The broad-spectrum survey spectra with pass energy (PE) of 150 eV and the high-energy resolution spectra (narrow spectrum of surface chemical functionality) with a PE of 20 eV were recorded. Prior to the measurements, the LIG surface was dried completely overnight in vacuum at room temperature.

Results and Discussion:

Non-woven materials were used to fabricate LIG. This included polyimide based non-woven substrate (P84), a PTFE coated P84 non-woven substrate (C-P84) and an aromatic polyamide (Aramid) non-woven substrate (AN). The fabrication of LIG was accomplished using a CO₂ laser at ambient atmosphere and the laser power and the scanning speed were varied (SI, FIG. 11A). As the laser power increased the electrical resistance of the surface decreased however a deeper ablation was seen on the substrate and melting of fibers on the backside was seen at the highest power setting. Thus, optimized settings were chosen that took into account an intact nonwoven substrate with a uniform LIG surface texture with a low electrical resistance FIG. 18A-18c). LIG could be achieved on each substrate and similar electrical resistance, pressure drop, and surface texture were observed for each substrate. However, the lowest bacterial passage was observed for LIG coated C-P84 filters in preliminary bacterial filtration (FIG. 13) and detailed study and characterization was performed on the C-P84-LIG filters.

FIG. 15a shows LIG is generated on C-P84 non-woven fibrous material using a 10.6 μm CO2 laser; FIG. 15b i, iii—optical and microscopic images of surface structure of C-P84, ii—SEM image of the surface of C-P84, iv—microscopic image of C-P84-LIG which shows fibrous and porous nature, FIG. 15c shows SEM image of the C-P84-LIG, scale bar—200 μm, FIG. 15d shows Raman characterization of C-P84-LIG, FIG. 15e is XPS broad spectrum survey of C-P84, and FIG. 15f is a pressure drop analysis of non-woven surface before and after making LIG on UC-P84 and. C-P84.

Characterization first included optical assessment of the integrity of the LIG. LIG was made on the fibers of each substrate, however some differences were seen (FIG. 11C). For example, the shape of the fibers was maintained in the LIG made on P84 or AN, but a more amorphous structure was seen for LIG on C-P84. Each showed a similar Raman spectra typical of LIG.36,37. The Raman spectra of C-P84-LIG (FIG. 1d) showed the characteristic peaks for graphene at 1346 cm−1 (D peak), 1584 cm−1 (G peak) and 2695 cm−1 (2D peak). The D peak is induced by defects in sp2 carbon bonds, the G peak is the first-order allowed peak, whereas the 2D peak originates from second-order zone-boundary phonons. The 2D/G intensity ratio ca. 0.52 indicated good graphitization in C-P84-LIG. Similarly, the 2D/G intensity ratio of P84 and AN showed 0.59 and 0.55, respectively. Fluorine atoms were incorporated into the C-P84-LIG because of the PTFE coating as evidenced by X-ray photoelectron spectroscopy (XPS) (FIG. 15e), which showed the binding energy of C1s, O1s, F1s and S2p at 284.97, 532.87, 687.62 and 169.74 eV, respectively. The atomic % of C1s, O1s F1s and S2p were 68.0, 20.4, 9.0, 2.6 respectively, and indicated that a significant amount of fluorine was incorporated in LIG during lasing. For the pressure drop measurements, the C-P84 was significantly higher than the P84 substrate because of the dense PTFE coating. However, the lasing process removed this dense PTFE layer and all LIG coated filters were similar pressure drops of ca. 0.8 mbar at 0.32 L/sec (FIG. 15f).

Electrical conductivity and surface temperature was studied on C-P84-LIG samples and current-voltage (IV) relationships were plotted. The current increased linearly at lower voltages but increased more sharply at >10 V as the surface temperatures increased >75° C. (FIG. 14a). Joule heating resulted in a reduction of the sheet resistance. Ultimately, the temperature increased to ˜270° C. when 25.0 V were applied. Above 25 V, the C-P84-LIG began to deform significantly, probably because the non-woven substrates had PTFE fibers dispersed within the polyimide fibers fur mechanical strength, and the melting point of PTFE is ˜330° C. Therefore, the temperature should not exceed ˜250° C. to maintain the structural integrity of these samples. FIG. 14b reports the temperature as a function of power consumption. The 4 cm² sample required ˜75.5 W of power (˜19 W/cm2) for heating above 270° C.

FIG. 14a is an I-V curve for C-P84-LIG and temperature increment with applied voltage, FIG. 14b shows power consumption of heating of C-P84-LIG as a function of temperature, FIG. 14c shows effect of squeezing/coughing on the C-P84-LIG filters, respective CFU counts collected on LB agar plate as a function of current (mA), and FIG. 14d shows CFU counts on dried and pre-cooled surface when bacteria sprayed circular LIG filters (5 cm diameter).

Aerosolized bacteria were generated to test the biological filtering efficacy of the non-woven filters. We constructed apparatus in house in which aerosolized bacteria could be sprayed at a mounted filter and airflow through the filter was achieved using a vacuum pump (SI, FIG. 12A). C-P84-LIG filters of 5 cm diameter were fabricated, and two copper wires are attached in a parallel configuration using carbon glue, at a distance of 3.6 cm (FIG. 12D). The circular filters were mounted on a filter holder, the electrical leads were attached, and an LB agar plate was mounted just behind the filters. Compared to the experiments in which no filter was mounted, the C-P84 non-woven filter could reduce the passage of P. aeruginosa by 89-90%. For C-P84-LIG filters at 0 V, only a slight improvement was seen (91-92% reduced passage) and might be due to tie different morphology of the LIG on the fibrous substrate. However, increasing the voltage (1-20 V) resulted in up to 99% increased bacterial removal (FIG. 14c). At potentials >8 V, the filter surfaces were >50° C. and therefore the temperature might play a role in the increased efficacy of the filter. Also, after the LIG filter was wetted with the aerosol, the overall electrical current slightly increased by ˜10 mA, while decreasing the surface temperature. To decipher the roles of the surface temperature and the electrical current played on bacterial killing, we sprayed aerosolized bacteria on a dried C-P84-LIG filter at 0 and 20 V and compared it to the bacterial passage observed with a pre-wetted filter having a similar current, but a surface temperature <30° C. (FIG. 2d). Here only minor changes in bacterial passage were seen and showed that surface temperature played a minor role in the bacterial removal effects, while underlining the bactericidal effects of the electrical current.

FIG. 16a-16f show: Bacteria killing assay using titanium plate (FIGS. 16a and 16b) and LIG on PI substrate (FIGS. 16c and 16d). Effect of different resistance values of C-P84-LIG surface (FIG. 16e) on the killing of bacteria (FIG. 16f) at two different voltages (5.0 and 12.0 V).

To understand the role of current density on the killing of bacteria, we performed bacterial killing experiments on model surfaces. We chose titanium as a non-carbon containing control surface and LIG fabricated on dense polyimide substrates. On both substrates, despite being different materials, bacterial killing effects were seen at similar current densities at variable voltages (FIG. 17a-17d). For titanium, a current density of 2-3 mA/cm2 was sufficient to sterilize the surface compared to 8.5 mA/cm2 for the LIG surface in 2 min (FIGS. 17c and 17d). When the bacteria were exposed to the electrified LIG surface for 2-10 min, more efficient killing was seen at lower current densities, which confirms the current density and exposure time has a direct impact on bacteria killing (FIG. 19A-19C)). Keeping the voltage constant at 5 or 12 V, we fabricated C-P84-LIG on filters with variable resistance (4300, 540 and 59 ohms) leading to differences in current density (FIG. 16). When these filters were challenged with bacterial aerosols, 98.5 and 99.0% removal was seen at current density 6.53 mA/cm2 (59 ohm, 5 V) and 8.68 (59 ohm, 12 V) (FIG. 17d). Thus, the current density plays an important role to effect bacterial killing, and LIG with higher conductivity will lower the voltage necessary for effective antimicrobial air filtration.

FIG. 17a-17c show attachment of 4 cm×4 cm steel mesh on the surface of C-P84-LIG by carbon glue, FIG. 17d shows average current and current density measurement of the system, and FIG. 17e shows CFU passed through this system.

Thus, to increase the current density at lower voltages we designed a C-P84-LIG-stainless steel (SS) hybrid filter by attaching a steel mesh on the surface of LIG through carbon glue (FIG. 4a-c). This LIG-SS hybrid air filter had a significantly higher current density at lower voltages than the C-P84-LIG filter (FIG. 4d). The current density of 8 mA/cm2 could be achieved at 0.3 V and the filter removed 99% of the aerosolized bacteria. This is important as it can decrease the power consumption for such filters.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of sonic of the preferred embodiments. Other possible variations, modifications, and applications are also within the scope of the invention. Accordingly, the scope of the invention should not be limited by what has thus far been described, but by the appended claims and their legal equivalents.

1. An active air filter device for disrupting or destroying bacteria and/or viruses, said filter comprised of:
at least one layer of porous conductive material;
energy source creating current propagated throughout the said conductive material.

2. The active filter device of claim 1, wherein the porous conductive material is carbon-based porous material.

3. The active filter device of claim 1, wherein the porous conductive material has current density at the range of 6 mA cm⁻² to 20 mA cm⁻².

4. The active filter device of claim 1, wherein the porous conductive material is LIG (Laser-induced graphene) using fabricated LIG on non-woven polyimide fabric, without heating the substrate.

5. The active filter device of claim 1, wherein the porous conductive material comprises at least one of polyimide based non-woven substrate (P84), a PTFE coated P84 non woven substrate (C-P84) and an aromatic polyamide (Aramid) non-woven substrate (AN).

6. The active filter device of claim 2, wherein the Laser-induced graphene LIG is fabricated using a CO₂ laser at ambient atmosphere wherein the laser power and the scanning speed are varied.

7. The active filter device of claim 1, wherein the porous conductive material is made of one sided layer.

8. The active filter device of claim 1, wherein the porous conductive material is made of at least two sides layers.

9. The active filter device of claim 1, wherein the porous conductive carbon-based material is integrated with other active or passive layers of other materials including at least one of: polyester fibre (non-wetting), standard air filter, Chemical/Chemically as impregnated material by Antibiotics, Alcohol, Chlorhexidine, Iodine, or Metal-based material or Materials impregnated with metal, cooper and/or silver, and/or lead.

10. The active filter device of claim 1, wherein the energy source is controlled automatically by a control module, which is implemented as a management application on an associated computer device.

11. The active filter device of claim 1, wherein the current emerging from the energy source may be either a direct current or an alternating current, continuously, or intermittently at a given time and/or its form may be electric pulses of various shapes.

12. The active filter device of claim 1, wherein the current is pulsed in predefined cycles or according to predefined rules, wherein the predefined rules are based on the condition of the filter by sensing the cleanliness of the filter is or if bacteria or virus where detected on the filter.

13.The active filter device of claim 1, the filter materials comprise chemicals materials including antibiotics or alcohol.

14. The active filter device of claim 1, wherein material is pre-set to provide the static electricity.

15. The active filter device of claim 1, the static electricity emerge by the user, by rubbing the outside surface of the filter or by inner layers designed to be movably interconnected.

16. The active filter device of claim 1 used for a rooms air filtering independent device or as part of an air-condition system, in buildings or vehicles.

17. The active filter device of claim 1, comprising three layers, two conductive layers and in-between an insulating layer, wherein said layers function as capacitor, wherein one outer layer serves as the positive charge and the second one with negative charge.

18. The active filter device of claim 1, wherein a filter is sterilized at defined time periods by applying heat through the filter.

19. The active filter device of claim 1, further comprising electrical control part comprising a resistor connected through electrical connection to an external energy source device.

20. The active filter device of claim 1, wherein the filter is implemented in face mask.
